(19) United States
(12) Patent Application Publication
(10) Pub. No.: US 2021/0110619 A1
(43) Pub. Date: Apr. 15, 2021

(54) Parking system for a parking facility

(71) Applicant: Scheidt & Bachmann USA, Inc., Lowell, MA (US)

(72) Inventors: Norbert Miller, Mönchengladbach (DE); Konrad Rütten, Heinsberg (DE); Elmar Noll, Mönchengladbach (DE)

(21) Appl. No.: 16/601,699

(22) Filed: Oct. 15, 2019

(51) Int. Cl. G07B 15/04; G08G 1/14

(52) U.S. Cl. CPC G07B 15/04; G08G 1/149

(57) ABSTRACT

A parking system having at least one access arrangement with at least one access apparatus configured to control a passage from a first area with an access section into a further area. The arrangement includes a first display arranged at least adjacent to the access apparatus and at least one second display arranged remotely from the access apparatus. The displays are configured to display a parking tariff data set. At least one parking tariff control means is configured to change, upon a request, at least one parking tariff parameter so as to cause displaying of the changed parking tariff data set by the first and second displays. The parking system further includes at least one delay module configured to delay the displaying of the changed parking tariff data set by the at least one first display.

### TECHNICAL FIELD

The application relates to a parking system with at least one access arrangement. In addition, the application relates to a method for operating a parking system and a parking tariff control device.

### BACKGROUND ART

A parking system for at least one parking facility, such as car parks, multi-story car parks and the like, usually comprises one or more access arrangements. An access arrangement generally comprises one or more access apparatus(es). For example, a barrier with a pivoting barrier boom can be provided as an access apparatus. Such an access apparatus is used in particular to control the passage of a vehicle from a first area to a further area.

For example, a parking system may provide an access arrangement with at least one access apparatus to control a passage from an uncontrolled area to a controlled area, such as the parking area. In other words, entering the parking facility can be controlled by an access apparatus. Alternatively or additionally, a parking system may provide an access arrangement with at least one access apparatus to control the passage of a vehicle from the controlled area to the non-controlled area. In other words, exiting from the parking facility can be controlled by an access apparatus.

For known access apparatuses, entering a parking facility is granted, for example, after issuing a ticket by a control device of the access arrangement due to a user action. The ticket, in particular a paper ticket, is then paid for by a user at a parking kiosk at the end of a parking period and checked by a validator apparatus of an access arrangement when exiting. In the case of a positive check, the exiting is permitted by the access apparatus of the access arrangement. However, if the validator apparatus determines that, for example, the ticket has not yet been paid for, the access apparatus remains closed.

In order to display to a user of a parking system the costs for its use prior to the entering the parking facility, there is usually at least one first display in (immediate) proximity, i.e. adjacent, to the access apparatus, e.g. on the control device issuing the ticket. The first display is configured to display a parking tariff data set (e.g. costs or amount to be paid per time unit and/or the like).

However, it may occur that a parking system has a longer access section which branches off from a traffic route and leads to the access apparatus, so that a user cannot (sufficiently) perceive the first display when departing from the traffic route into the access section. However, after leaving for the access section, a user often has no possibility of reversing this decision. In other words, reversing the vehicle or the like by the user after driving into the access section is not possible or only possible with very great effort, so that the user has also to pass the access apparatus after driving into the access section. In other words, the entrance to a car park is often designed in such a way that—as soon as the user has driven into the access section—he also has to enter the car park.

In order to inform the user about the parking tariff data set of the parking facility before driving into an access section, it is known to arrange at least one second display for displaying the parking tariff data set at the access section, in particular at the beginning of the access section and thus remote from the first display and the access apparatus, respectively. The second display allows the user to learn about the parking tariff before turning into the access section.

Usually, the first display and the second display show the same parking tariff data set.

With newer parking systems, dynamic tariffing methods are increasingly being used in which a parking tariff parameter, such as a price per time unit, can be changed during ongoing operation. In particular, a parking tariff control device may be provided in known parking systems. This may be configured to control the at least one first display and the at least one second display upon a request to change at least one parking tariff parameter such that displaying of the changed parking tariff data set by the at least one first display and the at least one second display is caused. So, if the parking tariff is to be changed, then the parking tariff control device causes a change in the displayed parking tariff data set.

A problem with known parking systems with dynamic tariffing and at least one first display and at least one second display is, however, that a user has decided to drive into an access section on the basis of a parking tariff data set displayed on the second display. In particular, in the case of longer access sections, dynamic tariffing can result in that at least one parking tariff parameter changes, for example increases, whilst the user is still driving on the access section. In this case, the first display may then display a changed parking tariff data set, in particular with increased costs, compared to the parking tariff data set displayed on the second display when driving into the access section. This can result in that the user no longer wants to enter the parking facility.

Therefore, an object of the present application is to provide a parking system with dynamic tariffing, in which the disadvantages described above are at least reduced and, in particular, the user comfort is improved in a simple manner.

### SUMMARY OF THE INVENTION

The parking system of a first aspect of the present application comprises at least one access arrangement with at least one access apparatus, configured to control of the passage from a first area with an access section to a further area. The parking system comprises at least one first display, arranged at least adjacent to the access apparatus, configured to display a parking tariff data set. The parking system comprises at least one second display, arranged remotely from the access apparatus and at the access section, configured to display the parking tariff data set. The parking system comprises at least one parking tariff control device configured to actuate the at least one first display and the at least one second display upon a request to change at least one parking tariff parameter such that the displaying of the changed parking tariff data set by the at least one first display and the at least one second display is caused. The parking system comprises at least one delay module configured to delay the displaying of the changed parking tariff data set by the at least one first display compared to the displaying of the changed parking tariff data set by the at least one second display for a delay time period.

By providing, in contrast to the prior art and in accordance with the application, a parking system with dynamic tariffing, in which the displaying of a requested tariff change on the first display arranged adjacent to the access apparatus is delayed by a delay module according to the application compared to the displaying of the tariff change on the second display arranged remotely from the access apparatus, the user comfort is improved in a simple manner. In particular, it is enabled, in accordance with the application, that a user who decides to enter an access section and thus enter an adjoining parking facility on the basis of a parking tariff data set displayed on the second display can use the parking facility with that parking tariff data set, which was the basis of his decision, even if a change of at least one parking tariff parameter is requested whilst the user is still driving on the access section.

The parking system according to the application for a parking facility, such as a car park, multi-story car park or the like, comprises one or more access arrangement(s). An access arrangement comprises one or more access apparatus(es). Preferably, a barrier with at least one barrier boom pivotably arranged on a column can be provided as an access apparatus.

In front of an access apparatus (seen in the direction of passage), a first area is provided which is formed in particular by an access section which a vehicle, which will pass through the access apparatus, has to pass beforehand. The access section means in this case in particular the path section between an exit from a (public) traffic route, such as a road, to the parking facility (in particular without a further junction or the like along the access section).

The at least one access apparatus is configured to control the passage of a vehicle from a first area, in particular from the access section, to a further area. For example, in a parking facility at least one access arrangement with at least one access apparatus is provided to control the passage from an uncontrolled area to a controlled area, such as the parking area of the parking facility. In other words, entering the parking facility can be controlled by the at least one access apparatus.

Alternatively or additionally, at least one access arrangement with at least one access apparatus may be provided in the parking facility to control the passage from the controlled area to the non-controlled area. In other words, the exiting from the parking facility can be controlled by at least one access apparatus.

The parking system also comprises at least one first display located adjacent to the access apparatus. In particular, the first display is a stationary display.

In particular, a display is a display with variable content, such as an electronic display. A display is configured to display a parking tariff data set. A parking tariff data set may contain at least one changeable parking tariff parameter. For example, at least the amount to be paid for the use of the parking facility for a specific time unit can be displayed as a parking tariff data set. It goes without saying that further information such as the number of free parking spaces, opening hours etc. can be displayed on a display.

An “adjacent” arrangement of a first display to an access apparatus means in particular that the first display is visible to a user who is standing with his vehicle (directly) in front of (seen in the direction of passage) the access apparatus (and that in particular the displayed tariff data set is readable by the user). In particular, adjacent means that the first display has a maximum distance to the access apparatus of 5 m, preferably 2 m. The access arrangement may preferably include at least one first display next to the access apparatus.

An “at least adjacent” arrangement of a first display to an access apparatus means in particular that the first display may be adjacent to the access apparatus as defined above or may be a component of the access apparatus.

In addition, the access arrangement may comprise a (conventional) control device (e.g. for issuing tickets and/or controlling the opening of an access apparatus). The control device may, for example, issue a ticket on request in accordance with a currently valid parking tariff data set.

Hereby, according to the application, the currently valid parking tariff data set corresponds to the parking tariff data set currently displayed on the first display (not necessarily the parking tariff data set currently displayed on the second display).

For example, in an embodiment, a control device may comprise the at least one first display. It shall be understood that at least one further first display may be provided and/or a first display may be communicatively linked to the control device, for example.

The parking system also comprises at least one second display. The second display is located remotely from the access apparatus. Remote means in particular that there is a distance between the second display and the access apparatus which is greater than the distance between the first display and the access apparatus. The minimum distance between the second display and the access apparatus is in particular 6 m, preferably 10 m, especially preferred 15 m.

The second display is in particular a stationary display located at the access section, preferably at the beginning of the access section. In particular, the at least one second display can be arranged in such a way that the second display is visible to a user who is driving with his vehicle from a traffic route (directly) into the access section (and that, in particular, the displayed tariff data set can be read by the user).

The second display is configured (similar to the first display) to display a parking tariff data set.

The parking system also comprises at least one parking tariff control device. The parking tariff control device may, for example, be a local device of the parking facility (e.g. implemented in a local computer, control device and/or the like) and/or a device remote from the parking facility (e.g. implemented in a backend system). If the parking tariff control device is made up of several modules, the modules may be distributed.

The parking tariff control device is in particular communicatively linked to the first display and the second display (at least temporarily). Upon a request to change at least one parking tariff parameter (e.g. an amount and/or a time unit), the parking tariff control device at least actuates the at least one first display and the at least one second display to cause a change in the respective displayed parking tariff data set (corresponding to the at least one changed parking tariff parameter). In particular, a request triggers the actuation described above and a changing of the parking tariff data set valid for the use of the parking facility.

According to the application, the parking system comprises at least one delay module. The parking tariff control device may preferably comprise the delay module. For example, the delay module of a parking tariff control device may delay the actuation of the first display compared to the actuation of the second display. In particular, if a request to change a tariff data parameter is detected, the second display can be actuated immediately and the first display can be actuated with a delay. The first display and the second display in this embodiment are configured to display the changed parking tariff data set immediately upon receipt of an actuation signal (including, for example, a changed parking tariff data set).

It is also conceivable that the at least one first display comprises the at least one delay module. For example, upon receipt of an actuation signal (including for example a changed parking tariff data set) from the parking tariff control device, the delay module of the first display may delay displaying the changed parking tariff data set, while the at least one second display immediately displays the changed parking tariff data set upon receipt of a control signal (including for example a changed parking tariff data set).

The delay module causes a delayed displaying of the changed parking tariff data set by the at least one first display compared to the displaying of the changed parking tariff data set by the at least one second display for a (configurable) delay time period. The delay time period may be chosen in such a way that, when a user reaches the entrance, at least no worse, i.e. no higher, parking tariff data set is applied to that user than the one on which his decision to park here and now was based (i.e. the parking tariff data set displayed on the second display when the user turned into the access section).

As stated above, the current parking tariff data set of the parking facility (which is the basis for ticket generation and subsequent billing) corresponds (in error-free operation) to the parking tariff data set that is currently displayed on the first display.

According to a first embodiment of the parking system in accordance with the application, the delay time period may depend on the effect of the changed parking tariff parameter: the delay time period may in particular be greater than zero if the change in at least one parking tariff parameter causes an increase in a parking tariff. In particular, the delay time period may (essentially) be zero if the change of at least one parking tariff parameter causes a reduction of the parking tariff.

According to a further embodiment of the parking system in accordance with the application, the delay time period may depend on the distance to be covered by a vehicle between the installation location of the at least one second display and the installation location of the at least one first display. In particular, the distance may correspond to the distance between the beginning of the access section and the end of the access section. In particular, the distance covered (i.e. not the linear distance between the second display and the access apparatus) can be used to determine how much time a user approximately needs to reach the access apparatus and the first display, respectively, after the decision has been made to use the parking facility on the basis of the parking tariff data set displayed on the second display. It should be noted that for a plurality of second displays, the delay time period may preferably depend on the longest distance between a second display and the access apparatus and first display, respectively.

According to a preferred embodiment of the parking system in accordance with the application, the delay time period can essentially correspond to the time period a vehicle needs (at most) to cover the distance. This ensures with a high degree of reliability that a user can use a parking facility according to a parking tariff data set displayed on the second display, even if one or more parking tariff parameter(s) change(s) whilst covering the mentioned distance.

Alternatively, or in addition, according to a further embodiment of the parking system according to the application, the delay time period may depend on a preset first number of vehicles which have to pass through the access apparatus after a request to change at least one parking tariff parameter. In this case, in particular, no fixed delay time period is specified, but the length of the delay time period can vary. In particular, the number of vehicles passing through the access apparatus after a request to change at least one parking tariff parameter has been made may be determined, for example by a control device of an access arrangement, by a camera and an automatic image evaluation or the like. In particular, in a parking system the number of entering (and exiting) vehicles can be detected, and this feature can be used to count the vehicles upon an occurred request to change at least one parking tariff parameter.

In particular, the delay module may be configured so that the changed parking tariff data set is not displayed on the first display until the detected number of vehicles corresponds to (or exceeds) the preset first number of vehicles which must pass through the access apparatus, in particular from the time point of detection of a request to change at least one parking tariff parameter. The delay time period in this case corresponds to the time it takes for the preset first number of vehicles to pass through the access apparatus.

According to a preferred embodiment of the parking system in accordance with the application, the preset first number may correspond to the maximum number of (standard) vehicles (e.g. with an assumed (standard) vehicle length (e.g. of 4.5 m) and an assumed (standard) distance between two vehicles (e.g. of 1 m)) which fit in the distance between the installation location of the at least one second display and the installation location of the at least one first display. This ensures with a high degree of reliability that a user can use a parking facility according to a parking tariff data set displayed on the second display, even if one or more parking tariff parameter(s) change(s) during the covering the mentioned distance.

In an embodiment, both, a first preset and unchangeable delay time period depending on said distance may be predetermined, in particular on the time required for a vehicle to cover that distance, and a second variable delay time period corresponding to the time required for a preset first number of vehicles to pass the access apparatus, may be provided. For example, the delay module may cause the changed parking tariff data set to be displayed when an expiration of one of the first delay time period and the second delay time period is detected. In other words, the changed parking tariff data set is displayed as soon as one of the delay time periods has expired.

It has also been recognized that, for example, due to a malfunction in the access to the access apparatus, it may happen that a vehicle does not reach the first display until it already displays a changed, in particular increased, tariff data set.

In accordance with a preferred embodiment, the parking tariff control device may be configured to increase a transit grace time (period) by an additional transit grace time for an extension time period upon a request to change at least one parking tariff parameter. For example, the parking tariff control device may include at least one transit grace time adjustment module arranged to increase a transit grace time by an additional transit grace time for an extension time period in the event of a detection of a request to change at least one parking tariff parameter.

This aspect is in particular inventive on its own. Usually, a parking system provides for a so-called transit grace time during which a user is allowed to exit from the parking facility with his vehicle immediately after entering without having to pay a parking fee. This transit grace time for the passage of the vehicle is limited in accordance with the state of the art (during normal operation). In particular, it has been recognized that a transit grace time may not be sufficient if a plurality of vehicles wishes to exit from a parking facility one after the other immediately after entering due to a specific event, in particular a previously described change in tariff. According to this embodiment, the transit grace time is extended during an extension time period.

In particular, the additional transit grace time may be a predetermined fixed time, for example x min (e.g. 5 min). As an alternative or in addition, the extension time period can be a preset unchangeable period (e.g. 15 min). In other words, after changing a parking tariff parameter, the transit grace time is increased by (e.g.) 5 minutes for a duration of (e.g.) 15 minutes. The transit grace time is then reset to its original value.

In accordance with a preferred embodiment of the parking system of the application, the extension time period may depend on a preset second number of vehicles which have to pass through the access apparatus upon a request to change at least one parking tariff parameter. The second number may be different from the first number and preferably larger than the first number. In an embodiment, the first number can also be identical to the second number (or smaller). In this case, in particular, no fixed extension time period is set, but this can vary. During the extension time period, the transit grace time for entering vehicles is extended, in particular by the additional transit grace time.

In this case, the number of vehicles passing through the access apparatus after a change in at least one parking tariff parameter has been made may be detected, in particular, by a control device of an access arrangement, by a camera with automatic image processing or the like. The transit grace time for passage may be extended as long as a preset second number of vehicles has passed the access apparatus after a request to change at least one parking tariff parameter has been made, i.e. the detected number of vehicles is equal to (or exceeds) the second number. The user comfort can be further improved.

In addition, the parking tariff control device may be configured to enable displaying of a tariff change by at least one third display (such as display of a mobile or stationary user terminal device). This makes it possible, for example, for a user to obtain information about the currently valid parking tariff data set in advance via the Internet.

A further aspect of the application is a method for operating a parking system, in particular a previously described parking system. The parking system comprises at least one access arrangement with at least one access apparatus configured to control of a passage from a first area with an access section to a further area. The method comprises:
displaying, by at least one first display, arranged at least adjacent to the access apparatus, of a parking tariff data set,
displaying, by at least one second display, remotely arranged from the access apparatus and at the access section, of the parking tariff data set,
actuating the at least one first display and the at least one second display upon a request to change at least one parking tariff parameter such that displaying of the changed parking tariff data set by the at least one first display and the at least one second display is caused, and
delaying the displaying of the changed parking tariff data set by the at least one first display compared to the displaying of the changed parking tariff data set by the at least one second display for a delay time period.

A still further aspect of the application is a parking tariff control device for a parking system, in particular a previously described parking system. The parking tariff control device is configured to actuate at least one first display arranged adjacent to an access apparatus and at least one second display remotely arranged from the access apparatus and at an access portion of the access apparatus upon a request to change at least one parking tariff parameter such that displaying of the changed parking tariff data set by the at least one first display and the at least one second display is caused. The parking tariff control device comprises at least one delay module configured to delay the displaying of the changed parking tariff data set by the at least one first display compared to the displaying of the changed parking tariff data set by the at least one second display for a delay time period.

The parking tariff control device can be implemented in a local computing device of the parking facility (e.g. a local computer of the parking facility and/or a control device of an access apparatus) and/or in a remotely located backend system. The parking tariff control device may be formed by several modules which may be distributed.

It should be noted that, according to the present application, a device, unit and/or module is at least partly formed by hardware (e.g. processor, storage media, etc.) and/or at least partly formed by software (executable computer code).

The features of the parking systems, parking tariff control devices and methods can be freely combined with each other. In particular, features of the description and/or of the dependent claims, even with complete or partial circumvention of features of the independent claims, may be inventive in their own right or freely combined with each other.

### BRIEF DESCRIPTION OF THE DRAWINGS

There is now a plurality of possibilities to design and further develop the parking system, the method and the parking tariff control device. In this regard, reference is made on the one hand to the claims subordinate to the independent claims and on the other hand to the description of embodiments in connection with the drawings.

FIG. 1 is a schematic view of an embodiment of a parking system in accordance with the present application with an embodiment of a parking tariff control device in accordance with the present application.

FIG. 2 is a schematic view of a further embodiment of a parking system in accordance with the present application with a further embodiment of a parking tariff control device in accordance with the present application.

FIG. 3 is a diagram of an embodiment of a method in accordance with the present application.

### DETAILED DESCRIPTION OF SPECIFIC EMBODIMENTS

In the following, the same reference signs are used for the same elements.

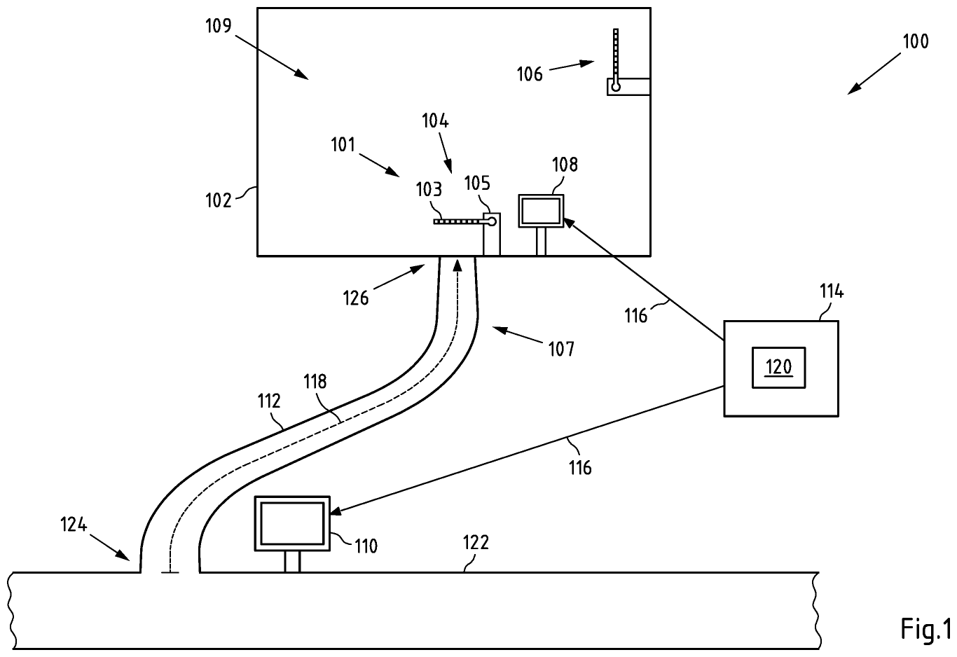

FIG. 1 shows a schematic view of an embodiment of a parking system 100 in accordance with the present application with an embodiment of a parking tariff control device 114 in accordance with the present application. The shown parking system 100 can be used in particular with a parking facility 102, such as a car park or multi-story car park, which in particular has a plurality of parking spaces. The parking system 100 is in particular a parking system 100 with dynamic tariffing.

Furthermore, the shown parking system 100 comprises an access arrangement 101 with an access apparatus 104 as an entry access apparatus 104. The access apparatus 104 is presently formed as a barrier 104 with a barrier boom 103 attached to a column 105. It shall be understood that other forms of access apparatuses can be used.

The access apparatus 104 is arranged to control the passage from a first area 107, in particular formed by an access section 112 (which is arranged in the direction of travel of a vehicle in front of the access apparatus 104), into a further area 109. When the access apparatus 104, as shown, is formed as an entry access apparatus 104, the first area 107 represents in particular an uncontrolled area 107 and the further area 109 represents a controlled area 109, in particular the parking area 109. In the case of an exit access apparatus 106, it is the other way round. It should be noted that the exit access apparatus 106 may be similarly formed to the entry access apparatus (for a better overview in FIG. 1, however, a more detailed inscription has been omitted). It shall be understood that two or more entry access apparatuses and/or two or more exit access apparatuses may be provided.

A controllable actuator (e.g. an electric motor) can be provided to enable a passage through the access apparatus 104. In particular, the actuator is configured to swivel the barrier boom 103 depending on a control signal.

As can also be seen, the parking system 100 comprises a first display 108. It shall be understood that two or more first displays can be provided. In the present example the access arrangement 102 comprises the first display 108. The first display 108 is in particular a dynamic display 108, for example a variable display 108. The first display 108 is arranged to display variable information in the form of character data, symbol data, number data and/or image data. The first display 108 is in particular configured to display the parking tariff data set that is currently valid when entering the parking area 109. For example, at least one amount per time unit (e.g. hour, day etc.) that must be paid for the use of the parking facility 102 can be displayed as a parking tariff data set. For example, it may be necessary to pay the amount before leaving the parking facility 102 at a parking kiosk (not shown).

The first display 108 is arranged (immediately) adjacent to the access apparatus 104, in the present example in particular adjacent to the column 105. In particular the first display 108 is arranged adjacent to the access apparatus 104 in such a way that it is visible to a user of a vehicle located (directly) in front of the access apparatus 104, i.e. of a vehicle located in the end area 126 of the access section 112. For example, the distance between the first display 108 and the associated access apparatus 104 is preferably less than 5 m.

An access section 112, which extends between a (public) road 122 and the parking facility 102, in particular the access apparatus 104, is shown in the present example, the access section 112 (e.g. at least longer than 10 m, preferably at least longer than 20 m) having an initial area 124, which adjoins the road 122, and an end area 126, which adjoins the parking facility 102 and the parking area 109, respectively. A user who has entered the access section 112 can normally leave it only by passing through the access apparatus 104.

In addition, it is apparent from FIG. 1 that the first display 108, at least the information shown on the first display 108, is not visible to a user of a vehicle from the road 122 and the initial area 124 of the access section 112, respectively.

Therefore, the parking system 100 comprises at least one second display 110 (which can be similarly formed to the first display 108). The second display 110 is arranged in particular remotely from the access apparatus 104 and at the access section 112 (and at the road 122), preferably at the initial area 124. The second display 110 (also) displays the parking tariff data set, in particular to enable a user to decide, based on the displayed parking tariff data set, to enter the parking facility 102 via the access section 112.

The tariff system used here is in particular a dynamic tariff system in which at least one parking tariff parameter can be changed during operation. For example, at least one parking tariff parameter (in particular a (monetary) amount) may be changeable depending on the current load and occupancy, respectively, of the parking facility 102. For example, it can be provided that the higher the load of the parking facility 102 is, the higher the amount (per time unit) is set, or the lower the load of the parking facility 102 is, the lower the amount (per time unit) is set. If the load changes (e.g. by a specific value), a request to change at least one parking tariff parameter can be generated.

Upon a request to change a parking tariff parameter (for example, due to a previously described and detected change in load (e.g., exceeding above/falling below a limit)), the parking tariff control device 114 actuates the at least one first display 108 and the at least one second display 110 such that displaying of the changed parking tariff data set by the at least one first display 108 and the at least one second display 110 is caused. In particular, actuation can be conducted via communication connections 116.

Hereby it is assumed that a particular parking tariff data set is valid for the use of a parking facility as long as it is being displayed on the first display 108, i.e. from the point-in-time when a changed parking tariff data set is displayed on the first display 108 until the point-in-time when a next changed parking tariff data set is displayed on the first display 108. In other words, in the present example, the first display 108 shows the currently valid parking tariff data set which is applied to a particular parking transaction started by passing through the access apparatus 104.

According to the application, the parking system 100 comprises at least one delay module 120. In the present example, the delay module 120 is integrated in the parking tariff control device 114. In other variants of the application, a delay module may also be integrated in a first display.

The delay module 120 is configured to delay the displaying of the changed parking tariff data set upon a request to change at least one parking tariff parameter, for example due to a detection of the current load of the parking facility 102 as described above, by the at least one first display 108 compared to the displaying of the changed parking tariff data set by the at least one second display 110 by a delay time period. In other words, the changed parking tariff data set is already displayed on the second display 110, while the currently valid parking tariff data set displayed by the first display 108 is still the unchanged parking tariff data set. Only after the delay time period has expired the changed parking tariff data set will be displayed on the first display 108 and thus be valid in particular for the use of the parking facility 102.

The delay time period may depend on the distance 118 to be covered by a vehicle between the installation location of the at least one second display 110 and the installation location of the at least one first display 108. In particular, the delay time period may substantially correspond to the time required by a vehicle to cover the distance 118 (at most). In particular, a specific standard speed of the vehicle can be assumed, e.g. 10 km/h. The distance 118 in this case corresponds in particular to the length of the track between the initial area 124 and the end area 126.

Alternatively or in addition, the delay time period may depend on a predetermined first number of vehicles which have to pass through the access apparatus 104 upon a detected request to change at least one parking tariff parameter. In this case, the number of vehicles passing through the access apparatus 104 after a request to change at least one parking tariff parameter has been made may be detected, for example by a (not shown) control device.

In particular, the delay module 120 may be arranged in this case so that the first display 108 for displaying the changed parking tariff data set is not actuated until the detected number of vehicles corresponds to (or exceeds) the preset first number of vehicles. In this case the delay time period corresponds to the time period required by the preset first number of vehicles to pass the access apparatus 104. Here the preset first number can correspond to the maximum number of (standard) vehicles (e.g. with an assumed (standard) vehicle length (e.g. of 4.5 m) and an assumed (standard) distance between two vehicles (e.g. of 1 m)) which fit in the distance 118.

In the present embodiment, the parking tariff control device 114 is a local parking tariff control device 114 of the parking facility 102. For example, the parking tariff control device 114 may be implemented in a local computer of the parking facility 102. An implementation in a control device would also be conceivable.

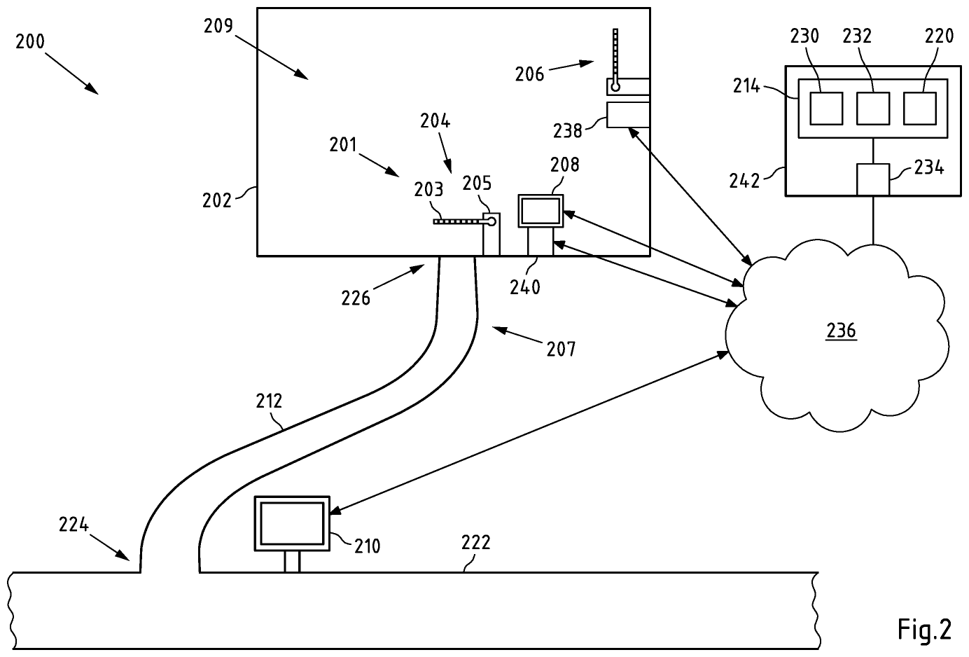

FIG. 2 shows a schematic view of a further embodiment of a parking system 200 in accordance with the present application with a further embodiment of a park tariff control device 214 in accordance with the present application. In order to avoid repetitions, only the differences to the embodiment of FIG. 1 are described below. For the other components of the parking system 200, please refer to the above explanations.

The access arrangement 201 comprises (in addition to an access apparatus 204 and a first display 208) a control device 240. In particular, the first display 208 is mounted on or comprised by the control device 240. For example, the control device 240 may, on request, issue a ticket corresponding to the currently valid parking tariff data set displayed on the first display 208. The control device 240 can then, for example, open the barrier 204 by controlling the actuator described above.

As can also be seen, a validator apparatus 238 is provided at the exit access apparatus 206. The validator apparatus 238 can be configured to receive and check a ticket. If the result of the check is that the ticket is valid (i.e. in particular a paid ticket), the validator apparatus 238 can cause a barrier 206 to be opened, for example by controlling an actuator described above.

Furthermore, the parking system 200 comprises a backend system 242 arranged remotely from the parking facility 202, for example formed by one or more (distributed) server/s. In the present example, the parking tariff control device 214 is implemented in the backend system 242.

The backend system 242 comprises a communication module 234, at least configured to communicate with components 208, 210, 238, 240 of the parking system 200 via a remote communication network 236. In particular the parking tariff control device 214 can actuate at least the first display 208 and the second display 210 via this, in addition the control device 240 and/or the validator apparatus 238. Hereby, by actuating the first display 208 a simultaneously actuating of the control device 240 can be conducted (or by actuating the control device 240 a simultaneous actuating of the first display 208 can be conducted).

In particular, at least the first display 208 and the second display 210 can be actuated in such a way that displaying of the changed parking tariff data set by the at least one first display 208 and the at least one second display 210 is caused.

The request to change at least one parking tariff parameter may be generated by a parking tariff adjustment module 232. For example, the parking tariff control device 214 may include the parking tariff adjustment module 232. In other variants of the application, a parking tariff adjustment module may also be implemented in a local computer, control device or the like.

For example, the parking tariff adjustment module 232 may generate a change in at least one parking tariff parameter based on at least one predetermined tariff change rule and the detected current load (for example, based on entry and exit data of the control device 240 and/or the validator apparatus 238), and then cause a corresponding actuating.

As previously described, at least one delay module 220 may delay the actuating of the first display 208 and control device 240, respectively, including the first display 208, upon receipt of a corresponding request. In other variants of the application, a delay module may also be integrated in a first display and/or control device. In this case, for example, when a control signal (including, for example, a modified parking tariff data set) is received from the parking tariff control device, the delay module may delay displaying of the changed parking tariff data set.

In addition, a transit grace time adjustment module 230 is provided in the parking system 200. For example, the parking tariff control device 214 may comprise the transit grace time adjustment module 230. In other variants, a transit grace time adjustment module may also be implemented in a local computer, a control device or the like.

The transit grace time adjustment module 230 can, upon detection of a generated request to change a parking tariff parameter, extend a transit grace time by a (preset and in particular fixed) additional transit grace time for an extension time period in order to provide vehicles or their users passing the access apparatus 204 during the extension time period with a longer time to exit from the parking facility 202. The extension time period may be fixed and/or may depend on a second number of vehicles which have to pass through the access apparatus 204 upon a request to change at least one parking tariff parameter.

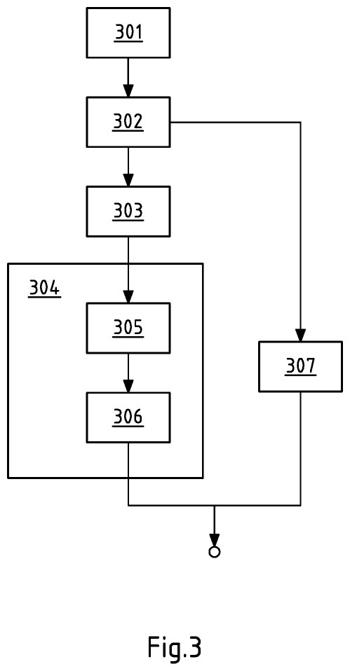

FIG. 3 shows a diagram of an embodiment of a method for operating a parking system, in particular a parking system according to FIGS. 1 and/or 2.

In a first step 301, a parking tariff data set is displayed by at least one first display arranged at least adjacent to the access apparatus.

In step 302 performed at least predominantly in parallel with step 301, a displaying of the parking tariff data set by at least one second display is conducted, wherein the second display is remotely arranged from the access apparatus and located at the access section.

In step 303, as described above, a request to change at least one parking tariff parameter can be generated.

Then, in step 304, the at least one first display and the at least one second display may be actuated upon detection of a generated request to change at least one parking tariff parameter such that displaying of the changed parking tariff data set by the at least one first display and the at least one second display is caused.

For example, in a sub-step 305 the at least one second display can be immediately actuated, while in a sub-step 306 actuating of the first display (and/or of the control device of the corresponding access arrangement) can be delayed by a delay time period. Thus, it is possible to delay the displaying of the changed parking tariff data set by at least one first display compared to the displaying of the changed parking tariff data set by at least one second display by a delay time period.

As described above, this may also comprise (almost) simultaneously actuating of the first and second displays and delaying the displaying of the changed parking tariff data set by the first display by a delay module of the first display (and/or the control device of the corresponding access arrangement).

Optionally, in step 307, a transit grace time can be increased by an additional transit grace time for an extension time period if a generated request to change at least one parking tariff parameter is detected.

What is claimed is:

1. A parking system comprising:
at least one access arrangement (101, 201) comprising at least one access apparatus (104, 204) configured to control a passage from a first area (107, 207) with an access section (112, 212) into a further area (109, 209);
at least a first display (108, 208) arranged at least adjacent to the access apparatus (104, 204) and configured to display a parking tariff data set;
at least one second display (110, 210) arranged remotely from the access apparatus (104, 204) and at the access section (112, 212) and configured to display the parking tariff data set;
at least one parking tariff control device (114, 214) configured to actuate the at least one first display (108, 208) and the at least one second display (110, 210) upon a request to change at least one parking tariff parameter such that displaying of the changed parking tariff data set by the at least one first display (108, 208) and the at least one second display (110, 210) is caused; and
at least one delay module (120, 220) configured to delay the displaying of the changed parking tariff data set by the at least one first display (108, 208) compared to the displaying of the changed parking tariff data set by the at least one second display (110, 210) by a delay time period.

2. The parking system according to claim 1, wherein
the delay time period is greater than zero if the change in at least one parking tariff parameter results in an increase in a parking tariff,
and/or
the delay time period is zero if the change of at least one parking tariff parameter results in a reduction of a parking tariff.

3. The parking system according to claim 1, wherein the delay time period depends on the distance (118) to be covered by a vehicle between the installation location of the at least one second display (110, 210) and the installation location of the at least one first display.

4. The parking system according to claim 3, wherein
the delay time period is substantially equal to the time required by a vehicle to cover the distance (118).

5. The parking system according to claim 1, wherein
the delay time period depends on a preset first number of vehicles which have to pass through the access apparatus (104, 204) upon a request of a change of at least one parking tariff parameter.

6. The parking system according to claim 5, wherein
the preset first number corresponds to the number of vehicles which at most can be accommodated on the path (118) between the installation location of the at least one second display (110, 210) and the installation location of the at least one first display (108, 208).

7. The parking system according to claim 1, wherein
the parking tariff control device (114, 214) is configured to increase a transit grace time by an additional transit grace time for an extension time period upon a request to change at least one parking tariff parameter.

8. The parking system according to claim 7, wherein
the additional transit grace time is a preset unchangeable period of time, and/or the extension time period is a preset unchangeable period of time.

9. The parking system according to claim 7, wherein
the extension time period depends on a preset second number of vehicles which have to pass through the access apparatus (104, 204) upon a request of a change of at least one parking tariff parameter.

10. The parking system according to claim 1, wherein the parking tariff control device (114, 214) comprises at least one delay module (120, 220) configured to delay the displaying of the changed parking tariff data set by the at least one first display (108, 208) compared to the displaying of the changed parking tariff data set by the at least one second display (110, 210) by a delay time period.

11. A method for operating a parking system according to claim 1, the method comprising:
displaying, by at least one first display (108, 208), arranged at least adjacent to the access apparatus (104, 204), of a parking tariff data set;
displaying, by at least one second display (110, 210) arranged remotely from the access apparatus (104, 204) and at the access section (112, 212), of the parking tariff data set;
actuating the at least one first display (108, 208) and the at least one second display (110, 210) upon a request to change at least one parking tariff parameter such that displaying of the changed parking tariff data set by the at least one first display (108, 208) and the at least one second display (110, 210) is caused; and
delaying the displaying of the changed parking tariff data set by the at least one first display (108, 208) compared to the displaying of the changed parking tariff data set by the at least one second display (110, 210) for a delay time period.

12. A parking tariff control device for a parking system, comprising:
a device configured to actuate at least one first display (108, 208), which is arranged adjacent to an access apparatus (104, 204), and at least one second display (110), 210), which is arranged remotely from the access apparatus (104, 204) and at an access portion (112, 212) of the access apparatus (104, 204), upon a request to change at least one parking tariff parameter such that displaying of the changed parking tariff data set by the at least one first display (108, 208) and the at least one second display (110, 210) is caused; and
at least one delay module (120, 220) configured to delay the displaying of the changed parking tariff data set by the at least one first display (108, 208) compared to the displaying of the changed parking tariff data set by the at least one second display (110, 210) by a delay time period.
